(19) United States
(12) Patent Application Publication
(10) Pub. No.: US 2008/0063749 A1
(43) Pub. Date: Mar. 13, 2008

(54) MEAD MAKING METHOD

(76) Inventors: Koji Tokuda, Hakusan (JP); Miyuki Aburatani, Hakusan (JP)

Correspondence Address: KING & SCHICKLI, PLLC, 247 NORTH BROADWAY, LEXINGTON, KY, 40507, US

(21) Appl. No.: 11/849,426

(22) Filed: Sep. 4, 2007

(30) Foreign Application Priority Data
Sep. 12, 2006 (JP) 2006-247047

(51) Int. Cl. C12G 3/00

(52) U.S. Cl. 426/11

(57) ABSTRACT

The invention provides a method for the production of tasteful mead that has an unheard-of dry taste, wherein honey with rice koji for shochu and yeast added thereto is subjected to primary fermentation. Preferably, a particular flavor may have been pickled in the honey for the extraction of the flavor therein, and black koji or white koji is used as the rice koji for shochu. Preferably, the weight of the rice koji for shochu is 1% to 10% of the weight of the honey plus the water added, and the amount of the water added is determined such that the sugar content of the honey amounts to 10% to 20%.

This application claims priority to Japanese Patent Application No. 2006-247047 filed on Sep. 12, 2006.

### TECHNICAL FIELD

The present invention relates to a method for making mead contains honey as a main ingredient.

### BACKGROUND OF THE INVENTION

Honey, because of containing limited amounts of amino acids that are the ingredients necessary for alcoholic fermentation, is less capable of fermentation with an insufficient buildup of alcohol.

Thus, most of meads have been of a lot more mild yet indistinctive taste; even the addition of amino acids or the like to them as a fermentation aid would rather spoil the taste.

In this regard, JP(A) 2005-000158 has come up with mead having an increased alcohol content by fermenting polyacid sake with the addition of honey to it during its production process, and then adding a slops screen agent to it for refinement and filtration.

### SUMMARY OF THE INVENTION

It may be possible to augment fermentative power by the addition of rice koji thereby increasing the buildup of alcohol; however, it is known that the use of rice koji for sake offers a problem that a unique, unfavorable taste remains in the sake product.

Situations being like such, the main object of the invention is to improve on fermentative power, thereby providing a method capable of making tasteful mead having an unheard-of dry flavor.

According to the invention, this object is achieved by the provision of a mead making method, characterized in that honey with rice koji for shochu and yeast added thereto is subjected to primary fermentation. The koji here means a preparation obtained by growing a kind of mold (usually Aspergillus oryzae) on boiled rice, barley, soybeans, etc., used as a starter for fermentations in sake and soy-sauce production, and the shochu means Japanese spirits distilled from sweet potatoes, rice, etc.

Preferably, a particular flavor may have been pickled in the honey for the extraction of the flavor therein, and black koji or white koji is used as the rice koji for shochu.

Preferably, the weight of the rice koji for shochu is 1% to 10% of the weight of the honey plus the water added, and the amount of the water added is determined such that the sugar content of the honey amounts to 10% to 20%.

### BEST MODE FOR CARRYING OUT THE INVENTION

The mead making method of the invention is characterized in that honey is subjected to primary fermentation with rice koji for shochu and yeast added to it.

Preferably, the honey used is one that is derived from a source having a pleasant, mild taste such as an acacia, a lotus flower, a clover, and a mandarin orange.

Among others, honey derived from the mandarin orange provides mead characterized by a preferable flavor unique to the citrus family.

A flavor may have been pickled in the honey to extract the flavor in it.

For that flavor, there is the mention of any desired flavoring edible sources such as an unripe green ume, mumes used for ume brandy, Citrus junos, Citrus sudachi, Citrus sphaerocarpa and Citrus limon (lemon), and herbs.

These sources, alone or in admixture, may have been pickled in the honey for the extraction of the flavor or flavors in it.

For the rice koji for shochu, either white koji or black koji may be used.

For the yeast, sake yeast, shochu yeast or wine yeast may be used, and yeast separated from honey may just as well be used.

Preferably in this case, the weight of the rice koji for shochu is 1% to 10% of the weight of the honey and the water added, and the amount of the water added is determined such that the sugar content of the honey amounts to 10% to 20%.

### EXAMPLE 1

Four point three liters of water were added to 1 kilogram of honey, to which 260 grams of rice koji for shochu (white koji) and 15 grams of sake yeast (on a dry basis) were then added for the primary fermentation at 15° C. to 30° C. for 3 to 8 days.

This primary fermentation brought the residual sugar content of the liquor down to 1% or less, and kept the proof to 10% or less as well.

Then, a further 1.2 kilograms of honey were added to the liquor which was then subjected to the secondary fermentation at 15° C. to 30° C. for 5 to 12 days.

And when the proof built up to 13% or higher, solid matters were separated off, and the liquor was filtered and refined to obtain the end mead.

The obtained mead was found to have a dry taste with decreased sugar contents, and be drinkable even at the table just like a dry white wine.

In the invention, two fermentation runs are carried out for the following reasons. The growth of yeast fungi is susceptible of being restricted by the proof too; only one single fermentation run requires high initial sugar contents and so plenty of fermentation is unlikely.

Even with multiple fermentations, sufficient secondary fermentation is unlikely when the primary fermentation run is carried out at an increased sugar content of 10% or more than 10%.

In consideration of labor and time, therefore, two fermentation runs would be optimum.

### EXAMPLE 2

A flavor (for instance, one or more lemon flavors) was pickled in honey for the extraction of that flavor in it.

Water was added to the honey with the flavor added to it such that the sugar content amounted to 10% to 20% in consideration of the water coming off the lemon or the like.

Then, rice koji (white koji) for shochu was added to the honey in an amount of 1% to 10% of the weight of honey plus water with a further addition of sake yeast (dry) for the primary fermentation at 15° C. to 30° C. for 3 to 8 days.

Here, the honey may just as well be fermented without removal of the lemon or other flavors.

This primary fermentation brought the remaining sugar content of the liquor down to 1% or less, and kept the proof at 10% or lower as well.

Another honey was added to the liquor in an amount of 1 to 1.5 times as much as the weight of the honey used for the primary fermentation for the secondary fermentation at 15° C. to 30° C. for 5 to 12 days.

And when the proof built up to 13% or higher, solid matters were separated off, and the liquor was filtered and refined to obtain the end mead.

The obtained mead was found to be a unique one that had the taste of the flavor added, quite different from the so-called liquor with flavoring fruits pickled in alcohol.

### ADVANTAGES OF THE INVENTION

By use of the rice koji for shochu, the fermentative power is improved with the addition of the taste unique to the rice koji, thereby successfully providing mead with reduced residual sugar contents yet with a dry, distinctive taste.

It is also possible to make a new alcoholic beverage having in it citric acid that is contained in the rice koji for shochu, and that is now taken as healthy as honey.

Further, by pickling the specific flavor in the honey, it is possible to make a novel alcoholic beverage having the preferable flavor unique to it.

The honey is fermented with the extraction of the flavor in it due to its high osmotic pressure; it is possible to produce an alcoholic beverage quite different from the so-called liquor with flavoring fruits pickled in alcohol.

What is claimed is:

1. A mead making method, characterized in that honey with rice koji for shochu and yeast added to honey thereto is subjected to primary fermentation.

2. The mead making method of claim 1, characterized in that a flavor has been pickled in the honey for extraction of the flavor therein.

3. The mead making method of claim 1, wherein the rice koji for shochu is white koji or black koji.

4. The mead making method of claim 2, wherein the rice koji for shochu is white koji or black koji.

5. The mead making method of claim 1, characterized in that the weight of rice koji for shochu is 1% to 10% of the weight of the honey plus the water added.

6. The mead making method of claim 2, characterized in that the weight of rice koji for shochu is 1% to 10% of the weight of the honey plus the water added.

7. The mead making method of claim 5, characterized in that the amount of the water added is determined such that the sugar content of the honey amounts to 10% to 20%.

8. The mead making method of claim 6, characterized in that the amount of the water added is determined such that the sugar content of the honey amounts to 10% to 20%.
